(19) United States
(12) Patent Application Publication
(10) Pub. No.: US 2013/0075408 A1
(43) Pub. Date: Mar. 28, 2013

(54) SECURITY MATERIAL FOR PACKAGING APPLICATIONS AND MERCHANDISE CONTAINERS WITH ANTI-THEFT FEATURES

(71) Applicants: Christian Elliot Childress, Thomson, GA (US); William Riddick Parkinson, Thomson, GA (US); Howard J. Trickett, Hartville, OH (US)

(72) Inventors: Christian Elliot Childress, Thomson, GA (US); William Riddick Parkinson, Thomson, GA (US); Howard J. Trickett, Hartville, OH (US)

(21) Appl. No.: 13/620,311

(22) Filed: Sep. 14, 2012

Related U.S. Application Data
(60) Provisional application No. 61/535,732, filed on Sep. 16, 2011.

(51) Int. Cl. B65D 90/02; B32B 29/08; B32B 29/00; B32B 3/08; B32B 3/28

(52) U.S. Cl. CPC B65D 90/022; B32B 3/08; B32B 3/28; B32B 29/002; B32B 29/08
USPC 220/560.01; 428/411.1; 428/182; 428/137; 442/1; 428/537.5

(57) ABSTRACT

A security material includes a base material combined with a security feature that inhibits slash-and-go thefts. The security material may be used to form merchandise containers, security inserts, merchandise shipping configurations, and merchandise shipping containers. The security feature may be one or more of a layer of wire mesh, perforated metal, screen, plastic, and fabric. A wire material such as hexagonal wire mesh commonly referred to as chicken wire or chicken mesh may be used. The chicken wire material may be a galvanized iron wire or PVC coated wire. The security feature may be disposed on an outer or inner surface or embedded within the base material.

### CROSS REFERENCE TO RELATED APPLICATIONS

This application claims the benefit of U.S. Provisional Patent application Ser. No. 61/535,732 filed Sep. 16, 2011; the disclosures of this application are incorporated herein by reference.

### BACKGROUND OF THE DISCLOSURE

1. Technical Field

The disclosure generally relates to containers for packaging and/or shipping merchandise. More particularly, the disclosure relates to a merchandise container that includes one or more security features that make it difficult for a thief to cut into or open the container to access the merchandise.

2. Background Information

High value, small-in-size merchandise such as electronics, jewelry, watches, pharmaceuticals, and the like are targeted by thieves because the merchandise is easy to transport and store before it can be resold. Some thieves target merchandise during the transportation phase of the merchandise wherein the merchandise is frequently packaged in corrugated cardboard shipping containers.

Although one method for stealing such merchandise is to steal an entire pallet full of merchandise using a forklift and a truck, thieves that break into shipping containers to steal a partial load of merchandise are an increasing problem. Such thieves gain access to a shipping container by cutting through an exposed sidewall of a cardboard shipping container that itself contains multiple small items of merchandise that themselves are already packaged in their individual display containers. A common method of gaining access is to use a box cutter or knife to cut an opening or a slit in a sidewall. These thefts are referred to as “slash and go” thefts. The merchandise is removed and the sidewall may be re-closed to disguise the theft. Another method is to open the tops of the containers and remove the individual merchandise boxes and then re-closing the containers to disguise the theft. Although the companies responsible for caretaking the goods have added different levels of security to their operations, the slash-and-go thefts continue and it can be difficult for the owner of the goods to pinpoint the location of the theft.

One device that has been used in the past to limit slash-and-go thefts is a lockable bag having a zippered opening. The bag includes a stainless steel mesh insert that resists cutting. US20080158002 discloses a security bag 300 using smart fiber 334 to identify when material has been cut. U.S. Pat. No. 6,995,669 discloses a system for enhancing the security of containers and the goods within the containers.

### SUMMARY OF THE DISCLOSURE

The disclosure provides a security material that may be used to protect from slash-and-go thefts. The material may be used to form merchandise containers and merchandise shipping containers. The material also may be used for container inserts, for wrapping containers, or for cushioning. The material is designed to provide for the safe transport of high value merchandise during shipment. The material includes at least one feature that resists cutting. The feature may be one or more of a layer of wire mesh, perforated metal (such as that used to protect loudspeakers), screen, plastic, and fabric. A wire material such as hexagonal wire mesh commonly referred to as chicken wire or chicken mesh may be used. The chicken wire material may be a galvanized iron wire or PVC coated wire. The security feature may be disposed on an outer or inner surface of the base material used to form the shipping container. The security feature may be secured with an adhesive, an interlocking connection, or mechanical fasteners. The security feature also may be disposed within the material or disposed between two layers of material. The base material may be a flexible material such as a plastic-based wrapping material or a flat foldable material such as a paper-based or polymer-based board materials such as that which are used to form boxes. The material may be a corrugated cardboard, a plastic wrap, a paper or paperboard sheet, a plastic board sheet, a protective packaging material with trapped air pockets such as that sold under the “Bubble Wrap” trademark, or a board-type material used to form boxes. The material may be supplied in rolls or sheets.

The material may be laminated with the security feature during the manufacturing process of the material. The security feature may be laminated between different layers of the material, connected with an adhesive, or secured with mechanical connectors such as staples or rivets.

The disclosure also provides a security laminate having a security feature and an adhesive that allows the laminate readily added to an existing container. The security feature is that resists cutting. The adhesive is used to connect the item to another section of packaging material. The adhesive may be protected with a release layer until it is ready to be used. The security laminate may be provided in sheets or rolls. A user may apply this security laminate to the inside of boxes to reduce the likelihood that a slash-and-go theft will be successful.

The disclosure provides a merchandise container having one or more security features that inhibit access to the container. The container may be a “D” container wherein one or more of the walls of the container include a feature that inhibits cutting. The container also may be sized for an individual item of merchandise. The feature may be integrated into the material of the container or added to the interior or the exterior of the container. The container having the security feature may be combined with a slip sheet or slip tray to allow the container to be readily moved with a forklift.

The disclosure provides a merchandise container wherein the walls of the container include an integrated security feature that resists cutting. The integrated security feature may be disposed on the exterior, the interior, or within the material that defines the walls of the container. In one configuration, the container is formed from double-wall thickness of standard container material with a security feature—such as an anti-cutting wire mesh—disposed between the two layers of material.

The disclosure provides a merchandise container wherein a security insert is disposed within a standard shipping container. The security insert includes one or more features that resist cutting. The security insert may be a four-sided insert, a five-sided insert, or a full six-sided insert. The seams or corners of the insert may be reinforced with an adhesive tape that itself carries a security feature such a wires or fibers. The seams or corners also may be reinforced by overlapping the sidewall materials to define double-thickness corners. The security inserts may be shipped to the user in a flat form that is erected to the condition where it is inserted into the container.

The disclosure provides a shipping configuration wherein a single container or a unitized load of containers is wrapped with a material that includes a security feature that inhibits cutting. These wrapped containers or loads may be combined with a slip sheet or slip tray that allows the unit to be readily moved with a forklift.

The disclosure provides a container with a lid or a top board that is secured with a cable seal that both makes it difficult to open the container and provides an indication that the lid has been opened. One example is a “D” container with a lid or top board that is held closed by a cable that is secured to the base of the container. The cable may be secured to the sidewalls, to the bottom of the container, or to both. The container itself may include a security feature that prevents the container from being accessed by cutting through a wall. The cable includes a seal that cinches the cable down on the lid after the lid is closed. The seal may be locked until broken or may be provided with a lock that is only openable with a specially configured key.

### DESCRIPTION OF THE DRAWINGS

FIG. 1 is a cross section of a security material having a base material in the exemplary form of a corrugated cardboard material having a security feature in the exemplary form of a single layer of wire mesh connected to one side of the base material to inhibit cutting of the corrugated cardboard.

FIG. 2 is a cross section of a security material having a base material in the exemplary form of a corrugated cardboard material having a security feature in the exemplary form of a single layer of wire mesh integrated or embedded within the body of the base material to inhibit cutting of the corrugated cardboard.

FIG. 3 is a cross section of a security material having a pair of base layers sandwiching the security feature wherein the base layers are in the exemplary form of corrugated cardboard and the security feature is in the exemplary form of a layer of wire mesh.

FIG. 4 is a cross section of a security material similar to FIG. 1 wherein the security feature is connected to an outer surface of the base material which in the FIG. 4 example is a flexible polymer-based packaging material that has a plurality of air pockets.

FIG. 5 is a cross section of a security material in the exemplary form of a laminate having a security feature that inhibits the cutting of the laminate.

FIG. 6 is a cross section of a “D” container made from a material having a security feature that inhibits the cutting of the container.

FIG. 7 is a perspective view of a four-sided security insert.

FIG. 8 is a side view of a container or a plurality of containers wrapped onto a slip sheet or slip tray with a wrapping material that includes a security feature that inhibits cutting.

FIG. 9 is a schematic side view of a container with a top plate that is secured with a cable that is attached to the sidewalls of the container.

FIG. 10 is a schematic side view of a container with a top plate that is secured with a cable that is attached to the bottom wall of the container.

FIG. 11 is a top perspective view of a merchandise container or a shipping container with a five- or six-sided insert manufactured from one of the security material configurations.

FIG. 12 is a perspective view of a container made from one of the materials having a security feature with portions of the outer material removed to show the security feature.

FIG. 13 depicts an exploded view of an outer container with a three piece insert (top, sleeve, and bottom) manufactured from a material that includes a security feature. Similar numbers refer to similar elements throughout the specification.

### DETAILED DESCRIPTION OF THE DISCLOSURE

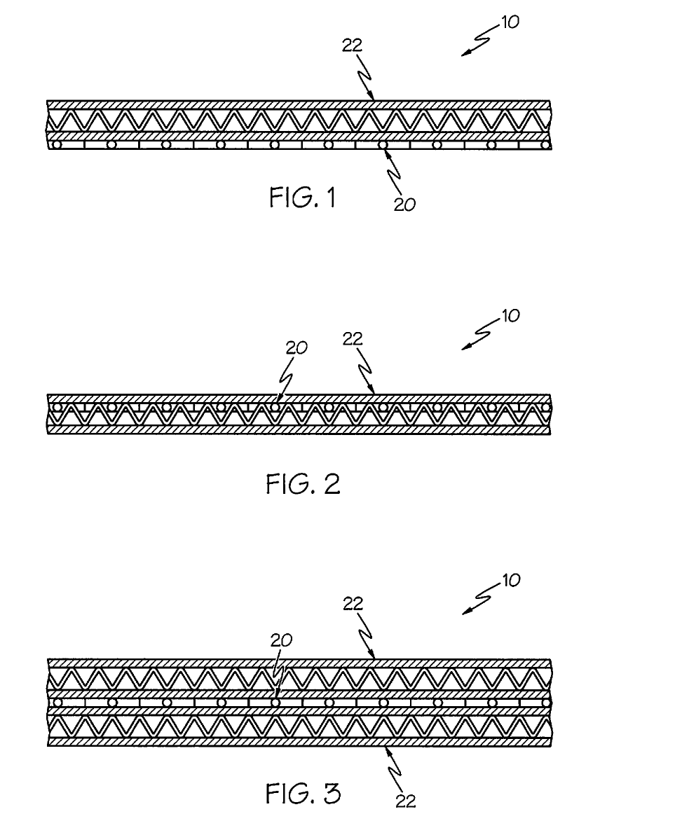

Exemplary configurations of security materials that may be used to protect merchandise from slash-and-go thefts are indicated generally by the numeral 10 in the accompanying drawings. A security material 10 may be used to form merchandise containers 12 and merchandise shipping containers 14 of a wide variety of sizes and shapes. Security material 10 also may be used for container inserts 60, for wrapping containers, or for cushioning. Security material 10 is designed to provide for the safe transport of high value merchandise during shipment. Security material 10 generally includes a base material 22 and at least one security feature 20 that resists cutting. Security feature 20 may be one or more of a layer of wire mesh (as shown in FIGS. 1-3), perforated metal (such as that used to protect loudspeakers), metal, plastic, or fabric screen, plastic, and fabric. A wire mesh material such as hexagonal wire mesh commonly referred to as chicken wire or chicken mesh may be used. The chicken wire material may be a galvanized iron wire or PVC coated wire. Chicken wire is made of thin, flexible galvanized METAL wire, with hexagonal gaps. Available in 1 inch diameter, 2 inch, and ½ inch (about 1.3 cm), chicken wire is available in various wire gauges usually 19 gauge (about 1 mm wire) to 22 gauge (about 0.7 mm wire). These typical gauges are difficult to cut with a knife and, when incorporated into a packaging material, inhibit cutting into the packaging.

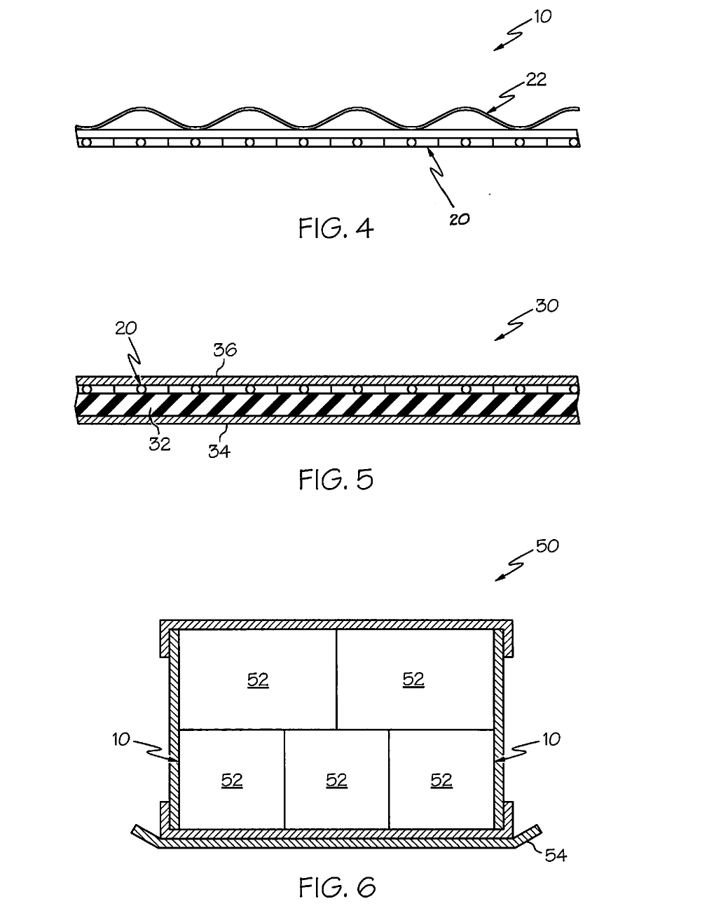

Security feature 20 may be disposed on an outer or on an inner surface of base material 22 such as the corrugated cardboard depicted in FIGS. 1-3. As shown in FIG. 2, security feature 20 may be disposed embedded within the base material 22 or disposed sandwiched between two layers of base material 22 as depicted in FIG. 3. The layers sandwiching security feature 20 may be the same material or different. Paper-based cardboard may be treated to resist moisture and liquids and may be sulfur-dipped cardboard. Base material 22 also may be another paper-based material, a plastic-based material, a combination of these materials layered together, or another packaging material. Base material 22 may be a flexible material such as a plastic-based wrapping material or a flat foldable material such as a board material such as that used to form boxes. The material may be a corrugated cardboard corrugated polymer, paperboard, plastic board, metalized polymer, a plastic wrap, a paper or polymer sheet, a protective packaging material with trapped air pockets such as that sold under the “Bubble Wrap” trademark (as shown in FIG. 4), or a board-type material used to form boxes. Security material 10 may be supplied in rolls or sheets. Security material 10 may be used to form containers or used to protect individual items within a container.

Security feature 20 may be secured with an adhesive, an interlocking connection, or mechanical fasteners such as staples, tie downs, and rivets. Material 10 may be manufactured by bringing together base material 22 and security feature 20 and securing the two together. The materials may be provided on rolls, unrolled and brought together to form material 10. Material 10 may then be rolled for shipment to the end user.

Base material 22 may be laminated with security feature 20 during the manufacturing process of base material 22. Security feature 20 may be laminated between different layers of material 22, connected with an adhesive, or secured with mechanical connectors such as staples or rivets.

Security feature 20 also may be provided as an add-on product that is secured to a container or a packaging material by the company packaging the high-value merchandise. In this configuration, security feature 20 is provided in the form of a security laminate 30 (FIG. 5) having security feature 20 and an adhesive 32 that allows the laminate 30 readily added to an existing container. Adhesive 32 is used to connect the laminate 30 to another section of packaging material. Adhesive 32 may be disposed on a backing layer 34 and may be protected with a release layer 36 until it is ready to be used. The user removes release layer 36 that contacts adhesive 32 through the openings of security feature 20. The user may then press adhesive 32 through the openings of security feature 20 to contact the section of packaging material that is to be protected. Security laminate 30 may be provided in sheets or rolls. A user may apply security laminate 30 to the inside of boxes to reduce the likelihood that a slash-and-go theft will be successful.

An exemplary merchandise container having one or more security features that inhibit access to the container is indicated generally by the numeral 50 in the accompanying drawings. Container 50 may be a “D” container or an individual merchandise container. A “D” container is used to hold a plurality of items 52 on a pallet or slip sheet or slip tray (generally indicated by numeral 54). The container has inside usable dimensions of 58″×41″×45″ and may include a removable wall panel for easy loading and unloading. The container may be fabricated from one of materials 10 such as the corrugated cardboard configurations.

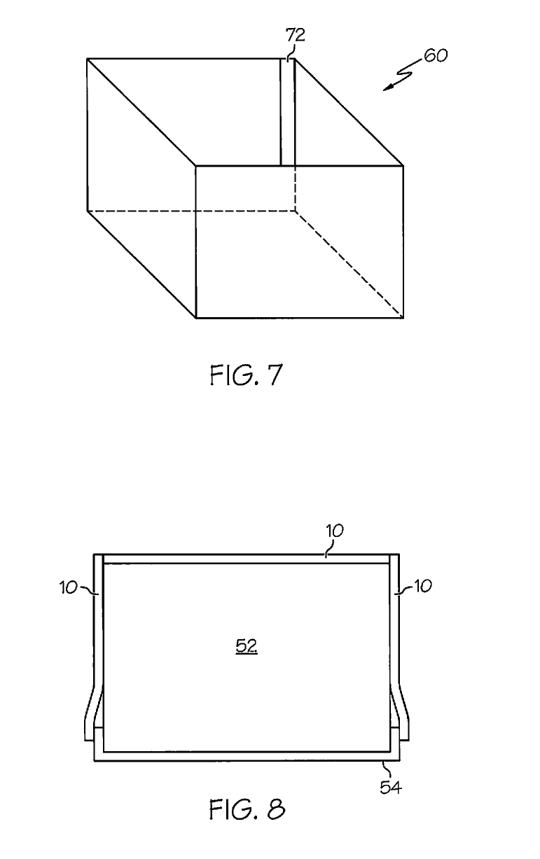

A security insert is indicated generally by the numeral 60 in FIGS. 7, 11, and 13. Insert 60 is fabricated from material 10 and may be placed within a standard shipping or merchandise container to protect the merchandise disposed within the container from slash-and-go thefts. Security insert 60 includes one or more security features 20 that resist cutting. Security insert 60 may be a four-sided insert, a five-sided insert, or a full six-sided insert. The four-sided configuration is a tube having open top and bottoms that fits snugly within the existing container. The five-sided configuration includes a bottom wall that may or may not include the security feature 20. The six-sided configuration is a second container that fits within an existing container. The lid of the six-sided configuration may be integral with the insert or removable. The seams or corners of insert 60 may be reinforced with an adhesive tape that itself carries a security feature such a wires or fibers. The seams or corners also may be reinforced by overlapping (as shown at reference numeral 72) the sidewall materials to define double-thickness corners. Overlapping the material to define double-thickness sections of material may be used to reinforce any desired portion of insert 60. Security inserts 60 may be collapsed and shipped to the user flat.

A shipping configuration is depicted in FIG. 8 wherein a single container or a unitized load of containers 52 is wrapped with a material—such as a plastic wrapping material - that includes security feature 20 that inhibits cutting. These wrapped containers or loads may be combined with a slip sheet or slip tray 54 that allows the unit to be readily moved with a forklift.

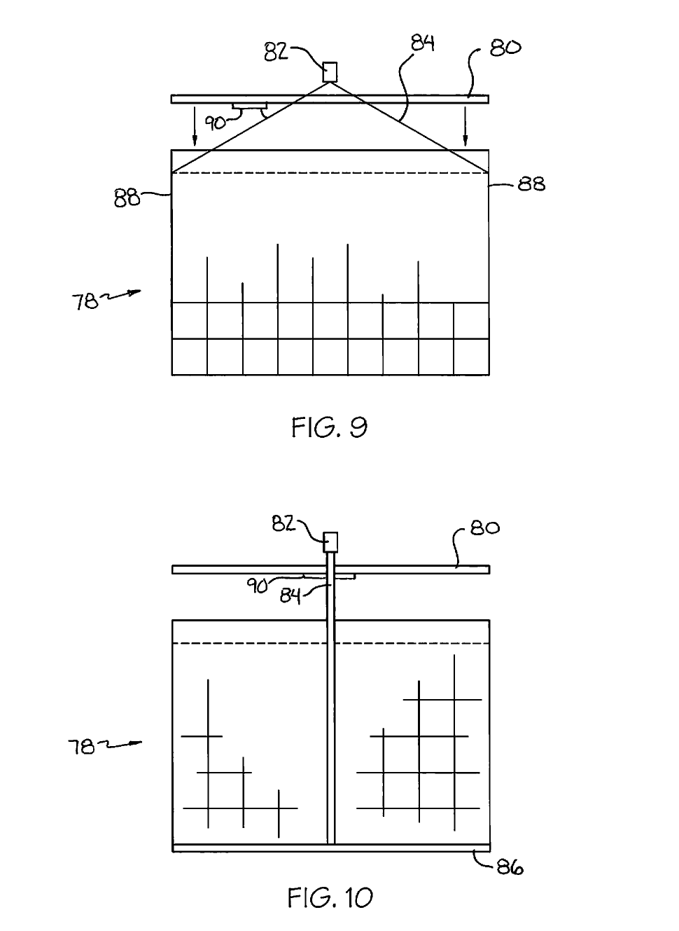

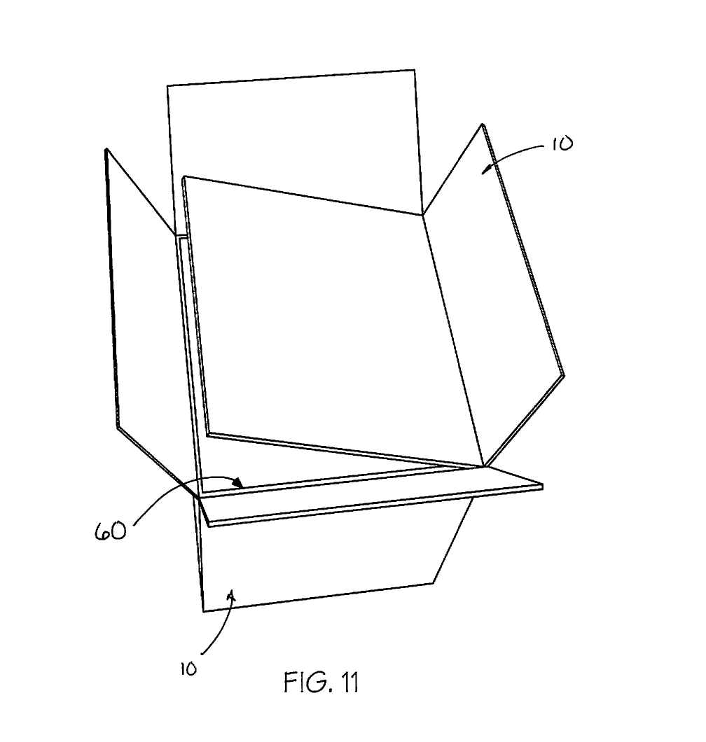

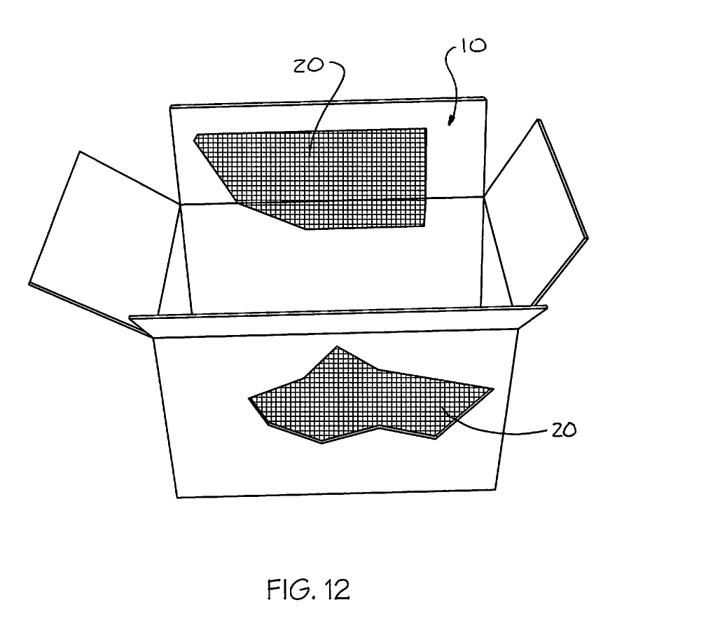

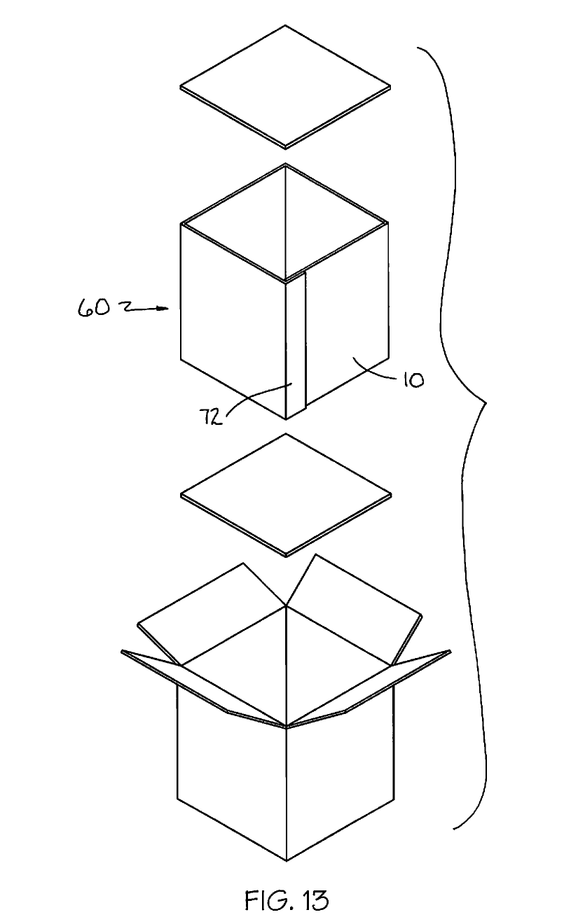

FIGS. 9 and 10 depict a container 78 or an insert 78 with a lid or a top board 80 that is secured with a cable seal 82 that both makes it difficult to open the container and provides an indication that lid 80 has been opened. One example is a “D” container 78 with a lid or top board 80 that is held closed by a cable 84 that is secured to the base 86 of container 78. Cable 84 may be secured to the sidewalls 88, to base 86 of container 78, or to both. The container itself may include a security feature 20 that prevents the container from being accessed by cutting through a wall. Seal 82 cinches cable 84 down on the lid 80 after lid 80 is closed over the merchandise disposed in container 78. Seal 82 may be locked until broken or seal 82 may be provided with a lock that is only openable with a specially configured key.

FIGS. 9 and 10 depict an arrangement for securing boxes or “D” containers with cable seal 82. This added protection includes a rigid or hardened top board 80 and cable seal 82 attached to cable 84 that passes through board 80 at eyelets carried by board 80. This adjustable cable seal 82 is cinched up to tighten board 80 over the top of the merchandise to minimize theft or tampering. Board 80 may be made of plastic or cardboard treated with sulfur for hardening.

Cable 84 may be conductive or may carry a conductive wire that is electrically connected to a battery-powered alarm 90 configured to be triggered when cable 84 is cut. Another configuration provides an electric device 90 that records the time and date when an element of the container is broken. The element may be the cable 84 that holds down board 80, a cable disposed in material 10, or an additional cable provided in the container.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A security material used to protect merchandise from slash-and-go thefts; the material comprising:
a base material; and
a security feature connected to the base material; the security feature being resistant to cutting.

2. The security material of claim 1, wherein the base material is a corrugated cardboard.

3. The security material of claim 2, wherein the security feature is embedded within the corrugated cardboard.

4. The security material of claim 2, wherein the security feature is connected to an outer surface of the corrugated cardboard.

5. The security material of claim 2, wherein the base material is sulfur-dipped.

6. The security material of claim 1, further comprising a second base material with the security feature sandwiched between the base material and the second base material.

7. The security material of claim 6, wherein at least one of the base materials is a corrugated cardboard.

8. The security material of claim 7, wherein the security feature includes a metal.

9. The security material of claim 1, wherein the security feature includes one of a layer of wire mesh, metal screen, and a perforated metal.

10. The security material of claim 9, wherein the security feature is galvanized.

11. The security material of claim 9, wherein the security feature is coated with a polymer.

12. The security material of claim 1, wherein the base material is one of a plastic wrap and a protective polymer-based packaging material with trapped air pockets.

13. The security material of claim 1, wherein the base material is one of a paper sheet and a paper board.

14. The security material of claim 1, wherein the security feature is connected to the base material with an adhesive.

15. A merchandise shipping container made at least partially from the security material of claim 1 wherein the merchandise shipping container is a “D” container.

16. A security laminate for use with a shipping material; the security laminate comprising:
a backing layer;
a security feature connected to the backing layer; and
an adhesive adapted to allow the security laminate to be readily added to an existing container.

17. The security laminate of claim 16, wherein the adhesive connects the security feature to the backing layer.

18. The security laminate of claim 17, wherein the security feature defines a plurality of openings; the adhesive being exposed through the openings.

19. The security laminate of claim 18, further comprising a release layer with the security feature disposed between the release layer and the backing layer.

20. A security device for protecting merchandise from slash-and-go thefts; the security device being adapted to fit within a shipping container to surround the merchandise that will be placed in the container; the device comprising:
a four-sided insert fabricated from a security material; the security material including a base material and a security feature connected to the base material; the security feature being resistant to cutting.

21. The device of claim 20, wherein the insert is in the form of a four-sided rectangular tube.

22. A merchandise shipping configuration comprising:
a carrier in the form of one of a slip sheet and a slip tray;
an item of merchandise in the form of one of a single merchandise container and a unitized load of merchandise containers; the item of merchandise being disposed on the carrier;
a layer of wrapping material disposed around a portion of the item of merchandise and around a portion of the carrier; and
the layer of wrapping material including a security feature that inhibits cutting.

23. The merchandise shipping configuration of claim 22, wherein the security feature is metal wire and the layer of wrapping material is polymer-based.

24. A merchandise container comprising:
a body having at least a base and a sidewall; the base and sidewall defining an area for receiving at item of merchandise;
a top plate; and
a cable securing the top plate to the body.

25. The container of claim 24, further comprising a cable seal connected to the cable above the top plate.

26. The container of claim 25, further comprising an electric device in communication with the cable.
